(19) United States
(12) Patent Application Publication
(10) Pub. No.: US 2006/0272022 A1
(43) Pub. Date: Nov. 30, 2006

(54) Securely configuring a system

(76) Inventors: Dmitrii Loukianov, Chandler, AZ (US); Dhiraj Bhatt, Portland, OR (US)

Correspondence Address: TROP PRUNER & HU, PC, 1616 S. VOSS ROAD, SUITE 750, HOUSTON, TX, 77057-2631, US

(21) Appl. No.: 11/140,842

(22) Filed: May 31, 2005

(51) Int. Cl. H04L 9/32; H04N 7/16; G06F 17/30; H04L 9/00; G06K 9/00; G06F 7/04; H03M 1/68; H04K 1/00

(52) U.S. Cl. 726/26; 713/176; 726/30; 726/2

(57) ABSTRACT

In one embodiment, the present invention includes a method of validating secure code using a first processor, loading configuration data into at least one configuration register of a conditional access unit if the secure code is validated, and preventing access to the configuration register(s) during normal operation. In such manner, encrypted content to be processed by the conditional access unit may be protected from unauthorized access. Other embodiments are described and claimed.

### BACKGROUND

Embodiments of the present invention relate to configuring a system and more particularly to securely configuring a system.

Integrated media processors such as systems on a chip (SoC) handle audio/visual content, which is considered valuable by content providers. Content providers therefore use a robust conditional access (CA) or digital rights management (DRM) system, which can unlock encrypted (i.e., scrambled) content for viewing by legitimate subscribers, while preventing unauthorized viewing by non-subscribers or extraction of the content to external devices or data connections. The low cost and large-scale deployments of such systems substantially increase their exposure to security attacks.

For various reasons, many CA implementations perform such functions as data stream parsing, decryption key generation and descrambling using configurable or programmable elements. These elements depend on data supplied in their registers by a processor. This processor is often shared with other applications for economical reasons. It is thus possible that the processor may provide access to this security configuration data to untrusted applications. Such access thus creates a means for unauthorized access to the high-value content.

A need thus exists to securely configure a system such as a conditional access system.

### BRIEF DESCRIPTION OF THE DRAWINGS

FIG. 1 is a flow diagram of a method in accordance with one embodiment of the present invention.

FIG. 2 is a block diagram of a system in accordance with one embodiment of the present invention.

FIG. 3 is a block diagram of a system in accordance with another embodiment of the present invention.

FIG. 4 is a block diagram of a system environment in accordance with an embodiment of the present invention.

### DETAILED DESCRIPTION

In various embodiments, configuration information used for processing of secure content may be protected from access during normal, unsecured operations of a system. In various embodiments, the system may be a personal computer (PC), set-top box, digital television, personal digital assistant (PDA), personal media player, secure terminal or another such system for handling secure content. The secure content may be digital content protected via a conditional access or digital rights management system. In some embodiments, the system may be a system on a chip (SoC) device or may include such a device.

In various embodiments, an access controller may be present to control access to elements of the system that use and process the secure data. Specifically, the access controller may prevent access to configuration registers associated with secure processing modules of the system. The configuration registers may be used to control decryption and other processing of the secure content. For example, configuration data stored in the configuration registers may control decryption according to one of different decryption algorithms. While the scope of the present invention is not so limited, in various embodiments algorithms such as Advanced Encryption Standard (AES), Rivest Shamir Adelman (RSA) or other such decryption algorithms may be accommodated. Via the access controller, unauthorized access to secure content may be prevented.

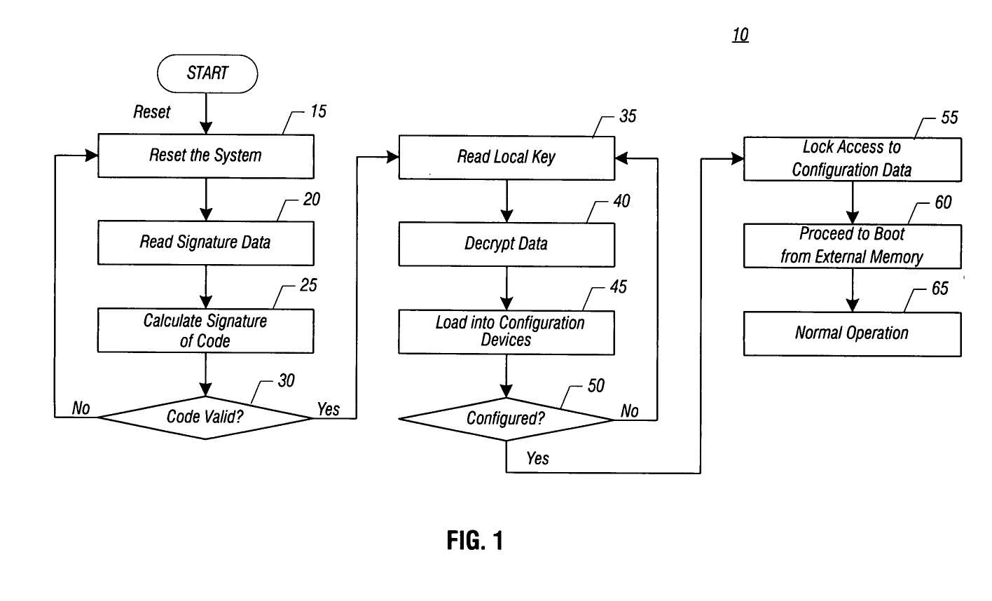

Referring now to FIG. 1, shown is a flow diagram of a method in accordance with one embodiment of the present invention. Specifically, method 10 may be used to initialize the system by loading secure configuration data into desired registers of the system, and then preventing unauthorized access to these registers. In various embodiments, method 10 may be implemented using instructions stored in an on-chip non-volatile memory, e.g., a read-only memory (ROM). These instructions and method 10 may be used to perform initialization of the system in a secure mode. If successful, the system may then be switched into a normal mode. At such time, control may pass to performance of instructions stored in an external memory, for example, and access to security configuration data may be prevented.

As shown in FIG. 1, method 10 is initiated by a reset signal. In various embodiments the reset signal may be generated upon powering up of the system via a power button, resetting the system via a reset button, or any other manner of generating a reset signal within the system. Upon receipt of the reset signal, the system is reset (block 15). During reset, various initialization routines are run in different processing units of the system to prepare them for access and to reset any values stored in volatile registers of these processing units.

In the embodiment described with regard to FIG. 1, the system may be a SoC, although the scope of the present invention is not so limited. Upon reset, a control processor (e.g., a central processing unit (CPU)) of the system may execute initialization software stored in a non-volatile memory of the system. For example, in some embodiments this code may be a basic input/output system (BIOS) or other low-level code of a system stored in a ROM. The ROM may be a factory programmable, mask programmable, one-time programmable or reprogrammable non-volatile memory. The initialization software may be a small amount of code used to enable the control processor to load additional initialization software (i.e., an extension) into random access memory (RAM) from another memory associated with the system. The associated memory may be a serial or parallel RAM, ROM, electrically erasable programmable ROM (EEPROM), flash memory, hard disk drive (HDD), or another type of volatile or non-volatile memory device. Still further in some embodiments, the associated memory may be a server or other storage device on a network to which the system is coupled.

The initialization software may direct the control processor to read signature data (block 20). More specifically, the control processor may read an expected signature of a software image resident within the associated memory. For example, in the context of a SoC, the memory may be an external memory coupled to the SoC via an external bus. Next, the control processor may calculate a signature of the software image (block 25). In some embodiments, the control processor may read the external software image and calculate a signature using an appropriate signature and/or hash function. In some embodiments, a key for verification of the signature may reside in a secure storage unit within the SoC. For example, the key may reside in a non-volatile secure identification (ID) storage unit.

Next, it may be determined whether the code is valid (diamond 30). In some embodiments, the internally computed signature may be compared with the expected signature obtained from the external memory to authenticate or validate the code. If the code is not validated, control returns to block 15, where the system is reset again. While not shown in FIG. 1, such resets may occur indefinitely or until a predefined number of attempts is made, after which the system may shutdown to reduce power consumption and prevent access. Thus if this code has been modified, corrupted or replaced, for example, by malware or code inserted by an unauthorized source (e.g., a hacker) to attempt to improperly access or use secure content, the control processor is not properly reset and operation of the system is prevented.

If instead at diamond 30 it is determined that the code is valid, control passes to block 35, where a local key is read (block 35). The local key may be stored in the secure ID storage of the system, and may be a decryption key. In various embodiments, this local key may be used to decrypt secure initialization data stored in the external memory. This secure initialization data may include, for example, code or microcode of a secure portion of the system, such as a CA or DRM module or other programmable logic device. In such manner, the local key may bind the external memory to a specific instance of the system (e.g., a specific instance of a SoC). Thus, the data is obtained from the external memory and is decrypted (block 40). Upon decryption, the initialization data, also referred to herein as configuration data, may be loaded into configuration registers of a conditional access portion of the system or other secure processing units of the system (block 45). Next it may be determined if the secure information was successfully loaded and the system is appropriately configured (diamond 50). If it is not successfully configured, control returns to block 35 for a further attempt to load the secure data. These further attempts may occur indefinitely or for a predefined number of attempts, after which the system will shut down.

If it is determined that the configuration was successful at diamond 50, control passes to block 55. There, access to the configuration information is locked (block 55). In some embodiments, an access controller may be activated to lock the configuration registers including the secure information and other portions of the system including, for example, the secure ID storage or other memories of the system. The lock condition may be set explicitly (for example, by allowing the control processor to write into a control register or similar instrument) or may be set implicitly on the first attempt to fetch and execute instructions from the associated external memory device.

After the configuration registers have been locked, a system may proceed to further bootstrap processing (block 60). More specifically, the system may be booted using instructions obtained from the external memory. When booting has completed, normal operation of the system may begin (block 65). During normal operation, secure content received by the system may be decrypted and provided to a display or other approved location, without allowing access to such secure content by nonsecure portions of the system.

During normal operation, the signature of the image stored in the external memory may be verified periodically in a background mode. If the signature should change (i.e., is not verified), the system may be reset. In turn, a reset into an initialization procedure, such as described above with regard to FIG. 1 may be performed.

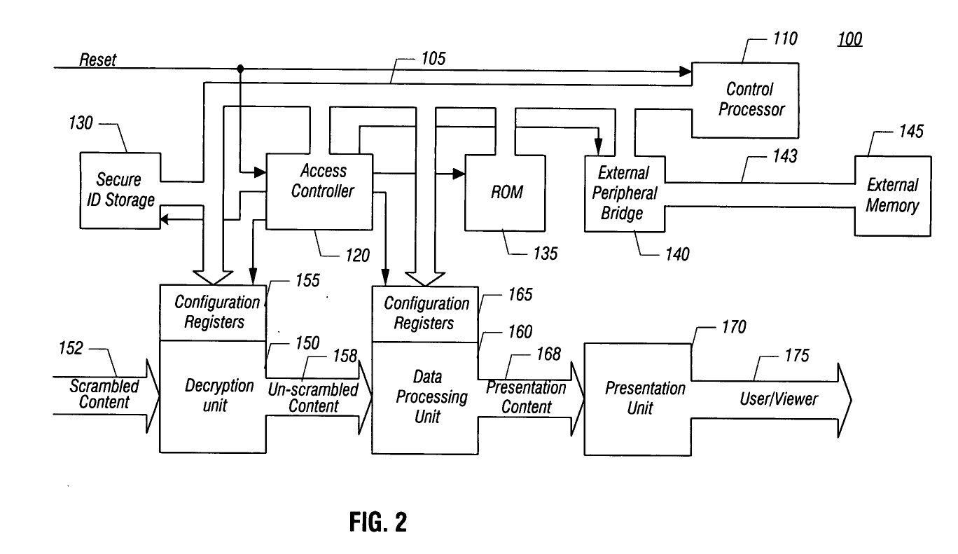

Referring now to FIG. 2, shown is a block diagram of a system in accordance with one embodiment of the present invention. As shown in FIG. 2, system 100 may be implemented using an SoC architecture, although the scope of the present invention is not so limited. Referring to FIG. 2, a control processor 110, which may be a CPU or other general-purpose microprocessor, is coupled to various memories and other processing units via a shared bus 105. Shared bus 105 may be shared by various modules within the system for transmission of both secure configuration data and non-secure data. Because internal data of the system may be transferred via this shared bus that is accessible by control processor 110 as well as other modules, access to shared bus 105 may be controlled using an access controller 120. In various embodiments, access controller 120 may include a cycle decoder and guarding logic to prevent access to shared bus 105 by at least certain modules of system 100 during secure transactions.

As shown in FIG. 2, access controller 120 is coupled to provide control signals, namely a select signal (shown as arrows extending from access controller 120), to various modules of system 100 including a secure ID storage 130, a ROM 135, an external peripheral bridge 140 and configuration registers 155 and 165. Unless enabled by the select signal, these modules do not have access to shared bus 105. In various embodiments, access controller 120 may operate in multiple modes including a secure transaction mode and a normal mode. In the secure transaction mode, configuration registers, security tokens and other secure elements may be accessible. In contrast, during normal mode, such devices may not be read (and in some embodiments written) by control processor 110, for example. The secure mode may be entered immediately after a reset signal is received. As shown in FIG. 2, the reset signal may be provided to access controller 120 and control processor 110. In some embodiments, the secure mode may be turned off (but not on) by control processor 110.

As shown in FIG. 2, external peripheral bridge 140 is coupled via an external interface bus 143 to an external memory 145. Access controller 120 may control external peripheral bridge 140 such that the bridge is disabled for on-chip data transactions. Accordingly, accesses to the on-chip units may not be exposed to any external locations, such as device pins of an SoC, for example.

In some embodiments, accesses in a secure mode may be restricted by other attributes. For example, in a multi-master bus, an initiator and a target of the access may be attributes to guide access controller 120 to enable or deny the bus transaction. For example, access to secure devices may be performed using the shared bus. However, such access may only be granted to transactions that are distinguished by master and target devices as being involved in the transaction. Furthermore, such transactions may be limited to the type of access requested (e.g., read, write, multi-word, single word, address region and the like). In some embodiments, secure access may be re-enabled after a password protected bus transaction to an access controller.

Further still, secure access to the configuration registers may be granted to permit dynamic reprogramming of their contents. For example, during operation a different encryption protocol may be accommodated by loading updated information into the configuration registers. Such updated configuration data may be obtained from an external memory or another source, such as from a content provider. For instance, the content provider may send an encrypted entitlement management message (EMM) that, if successfully decrypted by the system, will re-enable the control processor to access the secure registers. Since such enabling is performed in a controlled, secure manner, malicious software cannot re-enable such access under its sole control. In some embodiments, the service provider's request to enable dynamic reprogramming may be a prerequisite for such operation.

Another example of dynamic reprogramming is where there is an update to the code and configuration information resident in an external memory (such as a platform flash) under control of secure update (e.g., client) software running on the control processor. Such updates to the external memory may be performed such that a revised signature for the new code image is also provided to the client device by the service provider and written to the external memory. Under the control of the secure update client, the control processor is reset and executes the verification cycle shown in FIG. 1, for example.

Still referring to FIG. 2, shared bus 105 is further coupled to configuration registers 155 and 165 which are part of a conditional access system. As shown in FIG. 2, incoming secure data which may be, for example, scrambled digital content such as digital audio, video or other such content is received via a bus 152 in a decryption unit 150 associated with configuration registers 155. Configuration registers 155 are used to control operation of decryption unit 150 which operates to decrypt the scrambled content to provide unscrambled content to a data processing unit 160 via a bus 158.

In turn, data processing unit 160 is controlled by information in configuration registers 165. This information allows data processing unit 160 to perform various signal processing activities on the incoming data. Data processing unit 160 in turn provides presentation content to a presentation unit 170 via a bus 168. In some embodiments, presentation unit 170 may be a display, such as a monitor, television, projector or the like. Alternately, presentation unit 170 may be a buffer or other storage associated with data processing unit 160. From there, the unscrambled, accessible data is provided to an end user or viewer via a bus 175.

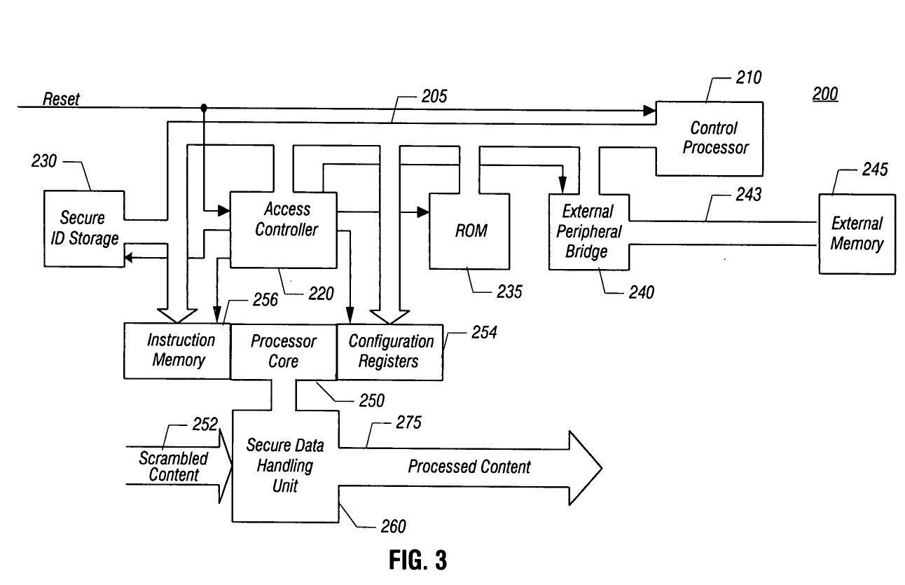

Referring now to FIG. 3, shown is a block diagram of a system in accordance with another embodiment of the present invention. As shown in FIG. 3, system 200 includes many of the same components as system 100 of FIG. 2. Specifically, as shown in FIG. 3, system 200 includes a control processor 210 which is coupled via a shared bus 205 to an access controller 220, a secure ID storage 230, a ROM 235 and an external peripheral bridge 240. An external memory 245 is coupled to external bridge 240 via an external interface bus 243.

System 200 differs from the implementation shown in FIG. 2 in that system 200 includes an embedded controller that acts as a secure processor core 250 as part of a secure data processing chain. As shown in FIG. 3, processor core 250 is coupled to an instruction memory 256 and configuration registers 254. Furthermore, processor core 250 is coupled to a secure data handling unit 260. In some embodiments, data handling unit 260 may include one or more fixed function logical units especially adapted to perform particular functions, such as particular decryption algorithms and the like. These functional units may be accelerators to perform different standards or protocols. Data handling unit 260 is coupled to receive scrambled content via a bus 252. Using data handling unit 260 and processor core 250, the scrambled content may be processed to obtain desired content accessible by an end user via a bus 275.

Thus in this embodiment, processor core 250 may act as a secure core as part of the data processing chain. Instruction memory 256 and configuration registers 254 may be loaded via shared bus 205 under control of control processor 210. In some embodiments, the secure code with which to load instruction memory 256 may be obtained from an external memory 245. The secure code downloaded may be used to perform various functions such as stream demultiplexing, descrambling or encryption functions. Using access controller 220, processor core 250 may perform desired CA or DRM functionality. Furthermore, the code loaded into instruction memory 256 may be prevented from being accessed by unprotected code later executing on control processor 210.

Once the secure code is loaded into instruction memory 256, access thereto is locked (i.e., except for access from processor core 250). In some embodiments, the secure code may be stored as an encrypted binary image in external memory 245. When this encrypted binary image is decrypted and loaded into instruction memory 256, access thereto is locked. During decryption, no decrypted image may be made available externally, thus creating a protected software domain. In such manner, control processor 210 may be prevented from access to code and data of processor core 250.

In different embodiments, other internal architectures implementing a mix of configurable devices, embedded processors and programmable microcode and state machines may be realized. In such embodiments, a read only memory may be present to execute initialization code to allow a control processor to perform initialization to obtain and load secure (e.g., decrypted) code into a secure processor. Then an access controller may prevent access to the security devices. Some of these embodiments may implement a point-to-point architecture or use independent bus links to provide an exclusive path for passing of secure configuration data. In such manner, this secure data is not shared with data and instruction paths used during normal operation.

In still other embodiments, multiple external memory devices may be connected to different interface channels. In such manner, the verification of code stored on more than one external memory device may be effected. From verified ones of these external memories, a selected code image may be obtained and loaded for execution, as described above. As an example, multiple removable secure storage devices may be coupled to a system in accordance with an embodiment of the present invention. These secure memory modules may be rented, sold, purchased or otherwise obtained by an end user to enhance or implement additional features of a system to which they are connected.

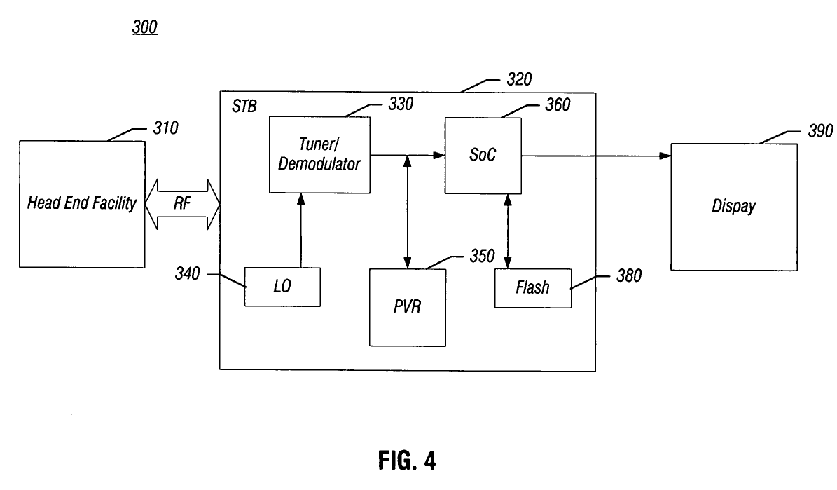

Referring now to FIG. 4, shown is a block diagram of a system environment in accordance with an embodiment of the present invention. As shown in FIG. 4, a system environment 300 may be used to provide desired content from a remote location to a display associated with a system in accordance with an embodiment of the present invention. As shown in FIG. 4, system environment 300 may include a head end facility 310. Head end facility 310 may be associated with a content provider, such as a cable company or a direct broadcast satellite (DBS) system. In still other embodiments, head end facility 310 may be associated with an Internet content provider. Desired content such as audio or video programming and the like may be encoded and scrambled at head end facility 310. The programming may then be transmitted via radio frequency (RF) signals, for example. Such signals may be transmitted via satellite, cable or other means.

At an end user location, e.g., a cable subscriber's residence, a set-top box 320 is provided. Set-top box 320 may be coupled to receive the RF signals via a coaxial cable or from a dish antenna, for example. Set-top box 320 may be used to tune into a selected channel and process the RF signals to provide processed content to a display 390, such as a monitor or television of the subscriber.

As shown in FIG. 4, set-top box 320 may include a tuner/demodulator 330 that receives the incoming signals. As discussed above, these signals may be received in a modulated and scrambled format. A desired channel may be tuned by mixing the modulated signal with a reference frequency obtained from a local oscillator (LO) 340, for example. Furthermore, tuner/demodulator 330 may demodulate the signals and provide them to a SoC 360. In some embodiments, SoC 360 may correspond to one of the systems shown in FIG. 2 and FIG. 3 and described above. However, it is to be understood that an implementation need not be a SoC and in other embodiments the components of SoC 360 may be separated into multiple devices. In some embodiments, tuner/demodulator 330 may further include an encoder, such as a moving picture experts group (MPEG) encoder to encode the demodulated signals. This encoded data may also be provided to a personal video recorder (PVR) 350 within set-top box 320.

SoC 360 may receive the incoming signals and decode them in accordance with configuration information stored in configuration registers. When SoC 360 generates processed decoded content, it may be provided to display 390 for viewing by the subscriber. As described above, in various embodiments an external memory, such as a flash memory 380, may be coupled to SoC 360 to provide the configuration data for storage in the configuration registers. In some embodiments, the configuration data may be stored in an encrypted format within flash memory 380. While shown as being a flash memory, it is to be understood that other non-volatile memories may be used. In other embodiments, the configuration data used to control SoC 360 may be received from head end facility 310.

Thus in various embodiments, unauthorized access to high-value content and data may be prevented. Furthermore, theft of service or denial of service may also be prevented. Using an embodiment of the present invention, the security of a CA or DRM system may be improved using the described hardware-based approach in which secure configuration data is loaded via a shared bus under control of a control processor. The configuration data is then protected from access by application software later running on the control processor.

Embodiments may be implemented in a computer program. As such, these embodiments may be stored on a medium having stored thereon instructions which can be used to program a system to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as ROMs, RAMs such as dynamic RAMs (DRAMs) and static RAMs (SRAMs), erasable programmable read-only memories (EPROMs), EEPROMs, flash memories, magnetic or optical cards, or any type of media suitable for storing or transmitting electronic instructions. Similarly, embodiments may be implemented as software modules executed by a programmable control device, such as a general-purpose processor or a custom designed state machine.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
validating secure program code obtained from a memory using a first processor of a system;
loading configuration data into at least one configuration register of a conditional access unit of the system if the secure program code is validated; and
preventing access to the at least one configuration register during normal operation.

2. The method of claim 1, further comprising preventing continued operation of the first processor if the secure program code is not validated.

3. The method of claim 1, wherein validating the secure program code comprises comparing a calculated signature for the secure program code with an expected signature for the secure program code obtained from the memory, and wherein the secure program code is encrypted in the memory, the memory comprising an external memory.

4. The method of claim 3, further comprising calculating the signature using a key obtained from a secure memory integrated in the system.

5. The method of claim 1, wherein loading the configuration data comprises decrypting encrypted configuration data obtained from the memory.

6. The method of claim 1, further comprising processing encrypted data received from a remote source in the conditional access unit according to the configuration data.

7. The method of claim 1, further comprising dynamically reprogramming the configuration data to accommodate a decryption protocol for processing encrypted content in the conditional access unit.

8. An apparatus comprising:
a first processor to execute an initialization routine of the apparatus;
a secure data handler coupled to the first processor to process secure content; and
an access controller coupled to the first processor via a shared bus to prevent access by the first processor to at least one configuration register associated with the secure data handler.

9. The apparatus of claim 8, further comprising a secure storage coupled to the shared bus, the secure storage to provide a security token to the first processor, the security token for use in validation of an external memory including at least a portion of the initialization routine.

10. The apparatus of claim 8, further comprising an external memory coupled to the shared bus to provide configuration data to the at least one configuration register if code of the external memory if validated.

11. The apparatus of claim 10, further comprising an external bridge coupled between the shared bus and the external memory, wherein the external bridge is to be disabled during data transactions associated with the secure data handler.

12. The apparatus of claim 8, wherein the apparatus comprises a system on a chip.

13. The apparatus of claim 8, wherein the access controller is to prevent access to the at least one configuration register in a normal mode of operation.

14. The apparatus of claim 8, wherein the secure data handler is dynamically programmable via the at least one configuration register to handle an encryption protocol in which the secure content is encrypted.

15. A system comprising:
a first processor to validate initialization code;
a controller coupled to the first processor to allow the first processor to load configuration data into at least one configuration register of a second processor and then to prevent the first processor from access to the at least one configuration register; and
a local oscillator coupled to provide a reference signal to mix with an incoming modulated signal, the incoming modulated signal including encrypted content to be processed in the second processor.

16. The system of claim 15, further comprising a first read only memory (ROM) coupled to the first processor to store a code block to cause the first processor to validate the initialization code, the initialization code stored in an external memory coupled to the system.

17. The system of claim 15, further comprising an external bridge coupled to the controller, the external bridge to be disabled by the controller when the encrypted content is processed.

18. The system of claim 15, wherein the system comprises a set-top box.

19. The system of claim 15, further comprising a shared bus coupled between the first processor, the second processor and the controller, wherein the controller is to control access to the shared bus.

20. An article comprising a machine-accessible medium containing instructions that if executed cause a system to:
validate secure code using a first processor;
load configuration data decrypted from the secure code into at least one configuration register of a conditional access unit if the secure code is validated; and
prevent access to the at least one configuration register by the first processor during normal operation.

21. The article of claim 20, further comprising instructions that if executed cause the system to prevent continued operation of the first processor if the secure code is not validated.

22. The article of claim 20, further comprising instructions that if executed cause the system to prevent an application executed on the first processor from access to the configuration data.

23. The article of claim 20, further comprising instructions that if executed cause the system to process encrypted data received from a remote source in the conditional access unit according to the configuration data.

24. The article of claim 20, further comprising instructions that if executed cause the system to dynamically reprogram the configuration data to accommodate a decryption protocol used to process encrypted content in the conditional access unit.

25. The article of claim 20, further comprising instructions that if executed cause the system to validate the secure code after reset or initialization, wherein the system comprises a system on a chip, and wherein the machine-accessible medium comprises an on-chip non-volatile memory.
